(19) United States
(12) Patent Application Publication
(10) Pub. No.: US 2023/0107320 A1
(43) Pub. Date: Apr. 6, 2023

(54) SELF-CLEANING TEXTILE SEAT

(71) Applicants: Accenture Global Solutions Limited, Dublin (IE); Advanced Functional Fabrics of America, Inc., Cambridge, MA (US)

(72) Inventors: Lavinia Andreea DANIELESCU, San Francisco, CA (US); Aditi MAHESHWARI, San Francisco, CA (US); Mark Benjamin GREENSPAN, San Francisco, CA (US); Michael REIN, Boston, MA (US); Charlotte FAIRLESS, Acton, MA (US); Frances LOGAN, Arlington, MA (US); Mary Jane SCHMUHL, Cambridge, MA (US); Emily ROBERTSON, Richmond, VA (US); Mihai IBANESCU, Arlington, MA (US); Tong HENG, Everett, MA (US); Bruce THOMPSON, Boston, MA (US); Kristen MULHERIN, Newton, MA (US)

(21) Appl. No.: 18/060,899

(22) Filed: Dec. 1, 2022

Related U.S. Application Data
(63) Continuation-in-part of application No. 17/335,344, filed on Jun. 1, 2021.
(60) Provisional application No. 63/032,979, filed on Jun. 1, 2020.

(51) Int. Cl. B08B 7/00; A47C 7/72; A47C 7/56

(52) U.S. Cl. CPC B08B 7/0057; A47C 7/56; A47C 7/72

(57) ABSTRACT

In some implementations, a self-cleaning seat includes a cover layer with a photocatalyst; a light-emitting fiber layer including one or more light sources; a light-diffusing spacer configured to diffuse light emitted from the light-emitting fiber layer and positioned between the cover layer and the light-emitting fiber layer; and a triggering mechanism that activates a cleaning cycle by activating the one or more light sources.

### CROSS-REFERENCE TO RELATED APPLICATION

This Patent Application claims priority to U.S. Provisional Pat. Application No. 63/032,979, filed on Jun. 1, 2020, and entitled “SELF-CLEANING DEVICE” and is a continuation-in-part of U.S. Pat. Application No. 17/335,344, filed on Jun. 1, 2021, and entitled “SELF-CLEANING DEVICE.” The disclosures of the prior Applications are considered part of and are incorporated by reference into this Patent Application.

### BACKGROUND

Many surfaces are contacted by multiple people throughout the day. These surfaces are typically cleaned manually on a periodic basis. However, such periodic cleaning may not be sufficient to prevent the spread of organic contaminants and germs prior to the next person contacting the surface.

### SUMMARY

This specification generally describes self-cleaning devices, such as self-cleaning textile devices. The surfaces can include a photocatalyst that is activated by a light source and that, when activated, cleans and/or decontaminates the surface. The light source can be embedded in the fabric of the device. In some implementations, the self-cleaning device includes one or more threads of light emitting diodes (LEDs) embedded in the fabric of the device and the fabric is coated with a photocatalyst, such as a type or form of titanium dioxide. Other light sources that are embeddable in or behind fabric can also be used in the threads. When the light source is on, the light emitted by the light source activates the photocatalyst causing the photocatalyst to clean and/or decontaminate the surface of the device. This cleaning cycle can be initiated by various triggering mechanisms.

According to some implementations, a self-cleaning device includes a fabric having a surface covered with a photocatalyst, one or more light sources embedded in the fabric, and a triggering mechanism that activates a cleaning cycle by activating the one or more light sources.

Implementations may include one or more of the following features. The one or more light sources can include one or more fabric threads including light sources embedded therein. The one or more fabric threads can be arranged in a pattern such that the one or more light sources emit light onto all areas of the surface when the one or more light sources are active. The one or more light sources can be arranged behind or under the fabric. The device can include a light-diffusing layer arranged between the fabric and the one or more light sources. Each light source can include an LED that emits ultraviolet (UV) light or an LED that emits visible light. The self-cleaning device can include a hydrophobic coating that coats the surface of the fabric. The self-cleaning device can include a light source arranged externally to the fabric surface and configured to activate the cleaning cycle.

The photocatalyst can include titanium dioxide. The photocatalyst can include titanium dioxide doped with one or more elements, the one or more elements including one or more of: lithium, sodium, magnesium, iron, cobalt, gold, vanadium, chromium, manganese, carbon, boron, iodine, fluorine, sulfur, nitrogen, or rare earth elements. The surface can be a surface of a seat, an arm rest, clothing, furniture, or the interior surface of a car (e.g., interior car door) or other vehicle.

The triggering mechanism can be configured to activate the one or more light sources based on a schedule or timer. The triggering mechanism can include a pressure sensor. The triggering mechanism can be configured to activate the cleaning cycle in response to detecting a decrease in pressure being applied to the pressure sensor. The pressure sensor can be disposed under or behind the surface. The triggering mechanism can include a light sensor. The triggering mechanism can be configured to activate the cleaning cycle in response to detecting at least a threshold intensity of light.

According to another implementation, a method for manufacturing a self-cleaning device includes obtaining a fabric, coating a surface of the fabric with a photocatalyst, and embedding one or more light sources in the fabric. Embedding the one or more light sources in the fabric can include embedding one or more fabric threads including LEDs into the fabric. Coating a surface of the fabric with a photocatalyst can include pre-treating the fabric using plasma treatment techniques, corona treatment techniques, or flame treatment techniques. The method can include coating the fabric with a hydrophobic coating.

According to another implementation, a self-cleaning seat includes a back portion that includes a fabric surface, a seat portion that includes a fabric surface, and a triggering mechanism. The fabric surface of one or more of the back portion or the seat portion includes a photocatalytic coating and one or more light sources embedded in the fabric. The triggering mechanism is configured to activate a cleaning cycle by activating the one or more light sources.

The one or more light sources can be arranged behind or under the fabric. Each light source can include one of a light emitting diode (LED) that emits ultraviolet (UV) light or an LED that emits visible light. The self-cleaning seat can include a light source arranged externally to the fabric surface and configured to activate the cleaning cycle.

The photocatalyst can include titanium dioxide. The photocatalyst can include titanium dioxide doped with one or more elements, the one or more elements including one or more of: lithium, sodium, magnesium, iron, cobalt, gold, vanadium, chromium, manganese, carbon, boron, iodine, fluorine, sulfur, nitrogen, or rare earth elements.

The back portion can include a plurality of back regions. Two or more back regions can each include one or more light sources embedded in the fabric. The triggering mechanism can be configured to selectively activate a cleaning cycle by activating the one or more light sources of the back region. The seat portion can include a plurality of seat regions. Two or more seat regions can each include one or more light sources embedded in the fabric. The triggering mechanism can be configured to selectively activate a cleaning cycle by activating the one or more light sources of the seat region.

The fabric surface of one or more of the back portion or the seat portion that includes the photocatalytic coating and the one or more light sources embedded in the fabric can further include a hydrophobic coating that coats the surface of the fabric.

The methods in accordance with the present disclosure can include any combination of the aspects and features described herein. That is, methods in accordance with the present disclosure are not limited to the combinations of aspects and features specifically described herein, but also may include any combination of the aspects and features provided.

The subject matter described in this specification can be implemented in particular embodiments so as to realize one or more of the following advantages.

In accordance with an aspect of the present disclosure, a fabric surface of a self-cleaning device is covered with a photocatalyst. When the photocatalyst is activated by light, reactive substances (e.g., hydroxyl radicals and superoxide radical anions) are formed. These reactive substances decompose organic compounds (e.g., to clean stains), eliminates bad smells, and kills organic contaminants, germs, and/or bacteria. Titanium dioxide in different types and forms has shown great potential as a powerful photocatalyst for various significant reactions due to its chemical stability, nontoxicity, and high reactivity. By leveraging these and other textile coatings, such as hydrophobic or polytetrafluoroethylene nanoparticles coatings, textiles can be created that are easy to clean, that can repel liquids and bodily fluids, and that can self-clean during the day reducing the potential for viruses and bacteria to build up on surfaces in public spaces and infect individuals.

Implementations of self-cleaning devices can include a triggering mechanism that initiates a cleaning cycle at appropriate times, e.g., when a person gets up from a self-cleaning seat. In this way, a self-cleaning seat can be cleaned after each use and prior to the next person sitting in the seat, making the seat more sanitary. For instance, energy may be conserved by only cleaning the surfaces when needed. As the seats are cleaned more frequently, the cleaning cycles can be shorter, further reducing energy consumption.

Implementations of the present disclosure can include one or more optional features that can improve the efficacy of the self-cleaning cycles. For instance, some types of fabric (e.g., fabric made of polyester fibers) may have chemically inert and nonporous surfaces with low surface tensions that make it difficult to adhere a coating. Pre-treating the fabric prior to coating may improve the adhesion of the coating to some types of fabric. Pre-treating the fabric can include washing the fabric to remove surface contaminants on the fabric. In some instances, a primer can improve the adhesion between the fabric and the coating. In instances in which a pre-treatment process has been performed, the coating may be applied as soon as possible after the pre-treatment process to improve coating retention and prevent a potential drop in pre-treatment efficacy.

Implementations of the self-cleaning devices can include additional elements that help to focus light from one or more light sources onto the fabric. Such elements can include reflectors built into the one or more light sources or reflective or refractive layers arranged adjacent to the one or more light sources to name some examples.

In some implementations, a self-cleaning seat includes a cover layer with a photocatalyst; a light-emitting fiber layer including one or more light sources; a light-diffusing spacer configured to diffuse light emitted from the light-emitting fiber layer and positioned between the cover layer and the light-emitting fiber layer; and a triggering mechanism that activates a cleaning cycle by activating the one or more light sources.

In some implementations, a method for manufacturing a self-cleaning seat includes obtaining a cover layer and a light-emitting fiber layer, the light-emitting fiber layer including a plurality of light sources; disposing a light-diffusing spacer between the cover layer and the light-emitting fiber layer; coating the cover layer with a photocatalyst; disposing a heat lamination layer, such that the light-emitting fiber layer is between the heat lamination layer and the light-diffusing spacer; disposing a reflective layer, such that the heat lamination layer is between the reflective layer and the light-emitting fiber layer, the heat lamination layer binding the light-emitting fiber layer to the reflective layer; and disposing a backing layer, such that the reflective layer is between the backing layer and the light-emitting fiber layer.

In some implementations, a self-cleaning seat includes a back portion that comprises at least one first self-cleaning device; a seat portion that comprises at least one second self-cleaning device; and a triggering mechanism, wherein the at least one first self-cleaning device and the at least one second self-cleaning device each include: a non-slip backing layer, a reflective layer disposed between the non-slip backing layer and a lamination layer, a spacer layer disposed between a cover layer and a light-emitting fiber layer including a plurality of light sources, wherein the light-emitting fiber layer is disposed between the spacer layer and the lamination layer, wherein a photocatalytic coating is disposed on the cover layer, and wherein the triggering mechanism is configured to activate a cleaning cycle by activating the at least one first self-cleaning device and the at least one second self-cleaning device.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example self-cleaning device.

FIG. 2 depicts an overview of a cleaning cycle.

FIGS. 3 and 4 each depict further examples of self-cleaning devices.

FIG. 5 depicts an overview of a method according to the present disclosure.

FIGS. 6A to 6H depict further examples of self-cleaning devices.

FIGS. 7A-7B are diagrams of example self-cleaning seats.

FIG. 8 is a diagram of an example fiber layer of a self-cleaning seat.

### DETAILED DESCRIPTION

The following detailed description of example implementations refers to the accompanying drawings. The same reference numbers in different drawings may identify the same or similar elements.

This document generally describes self-cleaning devices and methods for manufacturing self-cleaning devices. The self-cleaning devices can be in the form of (or a part of) various types of seats, arm rests, furniture, clothing, carpet, towels, oven mitts, pet beds, or other objects that can be made of fabric. For example, self-cleaning seats can be used in movie theaters, cars (e.g., private cars, ride-share cars, taxi cabs, rental cars), buses, airplanes, trains, boats, restaurants, or other vehicles or areas that multiple people come into contact with the seats.

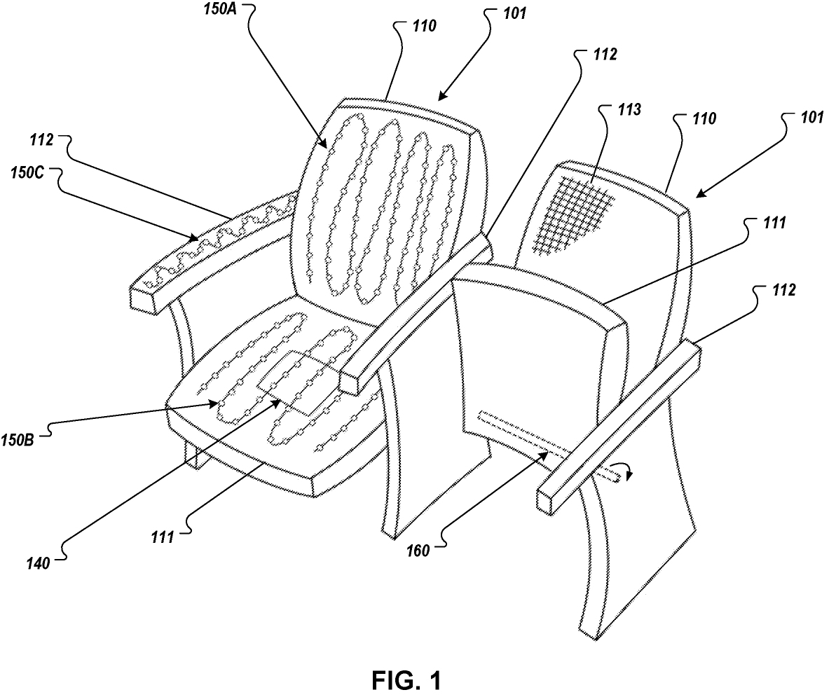

FIG. 1 depicts example self-cleaning seats 101. In this example, the self-cleaning devices are in the form of self-cleaning seats. The self-cleaning seats 101 include a back portion 110 having an outer surface 113 made at least partially of a fabric, a seat portion 111 having an outer surface made at least partially of a fabric, and arm rests 112 having an outer surface made at least partially of a fabric. A fabric may include a material made of textile fibers (e.g., by weaving or knitting the fibers). The seat portion 111 can be mounted to pivot about a rod 160. The seat 101 may include a resilient spring (not shown) that biases the seat 101 in the closed position shown on the right of FIG. 1. The seat portion 111 can be moved downward to the open position shown on the left of FIG. 1. When the seat portion 111 is released (e.g., when a person gets out of the self-cleaning seat 101), the resilient spring may return the seat portion 111 the closed position. The seats 101 may be part of a row of identical seats. In some instances, the seats 101 of FIG. 1 may be different (e.g., with respect to the fabric construction or the triggering mechanisms described below).

The fabric surface of each portion 110-112 of the self-cleaning seat 101 can be coated with a photocatalyst, such as a type or form of titanium dioxide (TiO2). When the photocatalyst is activated by light, reactive substances (e.g., hydroxyl radicals and superoxide radical anions) are formed. These reactive substances decompose organic compounds (e.g., to clean stains), eliminate bad smells, and kill organic contaminants, germs, and/or bacteria.

Visible light-responsive photocatalysts can be created by adding small amounts of cations and metal oxides by both chemical doping and physical ion-implantation methods to normally purely UV-active TiO2. Other modification methods include impurity doping (chemical and physical), semiconductor coupling, or dye sensitization, among other examples.

Some materials and/or techniques may be effective in enhancing TiO2’s photocatalytic properties with visible light, such as doping of TiO2 nanoparticles with Li, Na, Mg, Fe and Co nitrates; deposition of Au onto TiO2; doping of TiO2 with transition metals such as Cr, Fe and V; doping with rare earth elements; or doping of TiO2 with non-metal dopants such as C, B, I, F, S and N; among other examples.

For self-cleaning purposes, some (non-exhaustive) modifications to TiO2 include TiO2/SiO2/graphene oxide nanocomposites; porphyrin dye/TiO2 coating used for PET fibers; N-TiO2 film and loading AgI in cotton fibers; manganese doped TiO2 nanoparticles; TiO2 films modified with Au nanoclusters; TiO2-Al2O3 coatings; or TiO2/Pt/WO3 hybrid films; among other examples.

There are various ways to activate the photocatalyst of the self-cleaning seats 101. In one example, a light source (not shown in FIG. 1) disposed in the same room or area as the self-cleaning seats 101 can emit light onto the photocatalysts. For example, lights in the ceiling of a theater can activate photocatalyst of theater seats when the seats 101 are not in use (e.g., between movies).

FIG. 1 schematically shows an internal view of some of the fabric surfaces of the seats 101. The depicted elements may not be visible from the outside, as indicated by the seat 101 on the right that is in the closed position. In addition to light from outside light sources, each seat 101 can include one or more onboard light sources to activate the photocatalyst that covers the fabric surfaces. For example, the self-cleaning seat 101 includes a first thread of light sources 150A for the back portion 110, a second thread of light sources 150B for the seat portion 111, and a third thread of light sources 150C for each arm rest 112. Each thread of light sources 150A-150C includes a set of lights that can be turned on to activate the photocatalyst during cleaning cycles and turned off to end the cleaning cycles.

The lights in the threads of light sources 150A-150C and the other light sources described in this disclosure can include LEDs. The LEDs can be visible light LEDs that emit visible light or ultraviolet (UV) lights that emit UV light, among other examples, depending on the photocatalyst material. Traditional photocatalysts respond to ultraviolet light that can be produced in a variety of wavelengths (e.g., 100 - 400 nanometers (nm)) but these can cause damage to human tissues such as eyes and skin. Instead of using potentially harmful wideband UV light, a specific wavelength (e.g. 222 nm) of far-UVC may be chosen instead. The TiO2 coating can be modified by doping with abovementioned elements to have antibacterial and cleaning effects when activated by visible light (400-700 nm) alone, as described above.

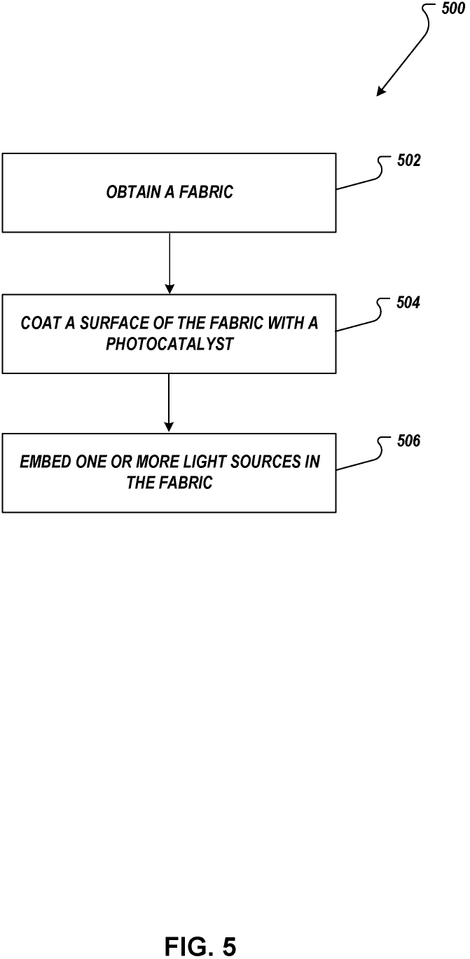

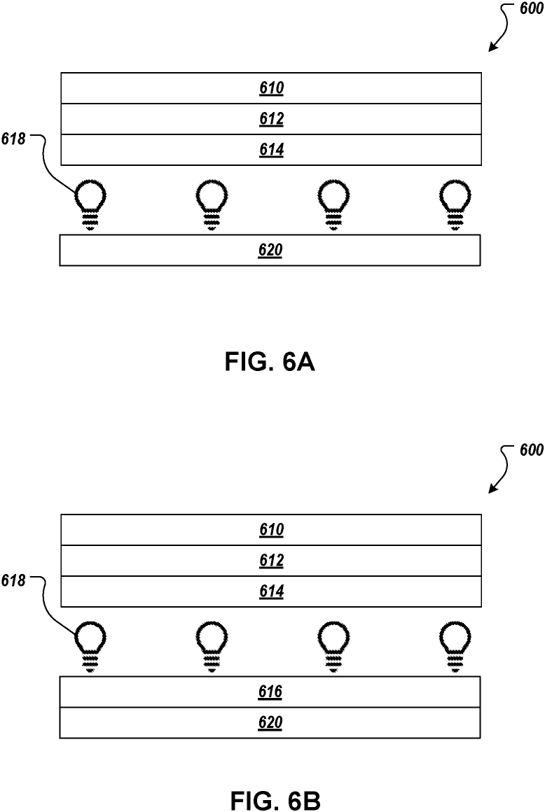

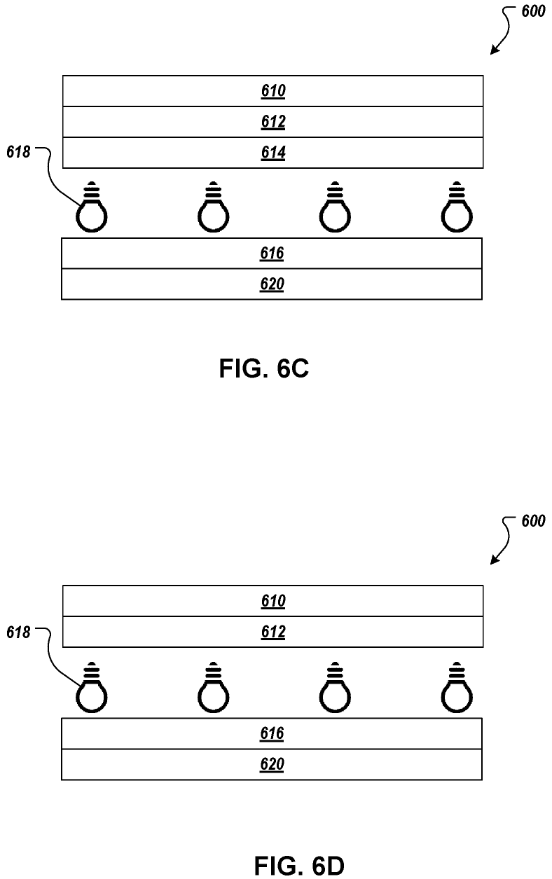

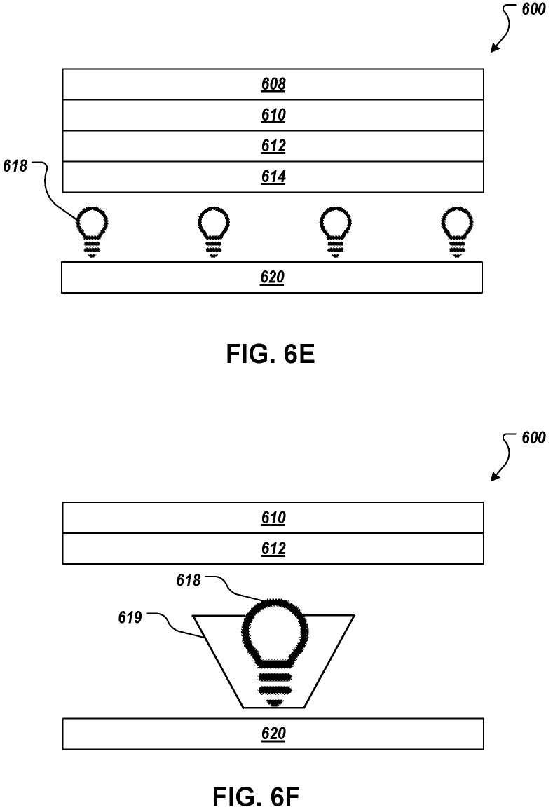

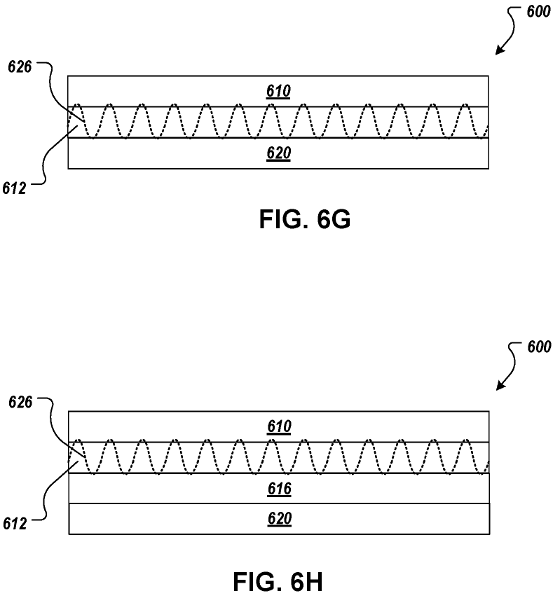

The light sources can be very small LEDs that are embedded in fibers that make the fabrics light up at scale. That is, each thread of light sources 150A-150C can include a thread of fibers with LEDs embedded therein. Such light sources can include LED strands, LED fibers, fiber optics, or electroluminescent wires. The threads of light sources 150A-150C can be interwoven into the fabric of the back portion 110, the seat portion 111, and each arm rest 112, respectively. In another example, the threads of light sources 150A-150C can be disposed under or behind the fabric surfaces. Although FIG. 1 depicts threads of light sources 150A-150C, implementations of the self-cleaning seats 101 can also include the light sources described (e.g., in reference to FIGS. 5 and 6A to 6F).

The light sources can be arranged such that the light emitted by the light sources diffuse and hit every part of their respective fabric surface. This arrangement can include an appropriate spacing between adjacent light sources and an appropriate spacing between adjacent runs of light sources from one end of the fabric surface to the other end of the fabric surface. The spacing can be based on the size of the light sources, the intensity of the light sources, and/or the type of fabric in which the light sources are embedded.

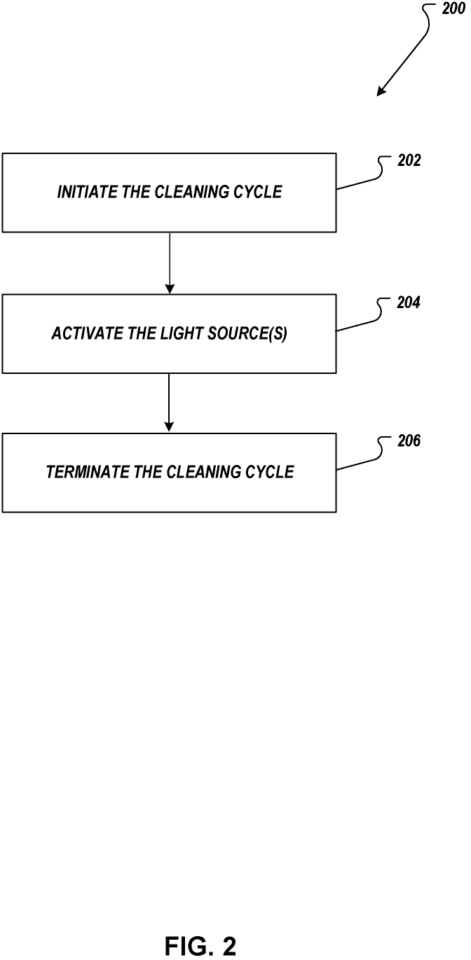

FIG. 2 is a schematic overview of an example cleaning cycle 200. The cleaning cycle 200 can include initiating 202 the cleaning cycle, activating 204 one or more onboard and/or external light sources, and terminating 206 the cleaning cycle. The cleaning cycle 200 is applicable to any of the self-cleaning devices of the present disclosure.

The cleaning cycle can be initiated using a triggering mechanism. In some instances, the seat 101 includes a triggering mechanism 140 that is arranged in the seat portion 111. For example, the triggering mechanism 140 can include a pressure sensor installed in the seat portion 111. The pressure sensor can include a pressure-sensitive sheet, e.g., Velostat™, force sensitive resistors, or another appropriate type of pressure sensor. The pressure sensor can also include conductive thread or fabrics that make contact with one another when pressure is applied. The triggering mechanism can also include a controller, e.g., a microcontroller or other control circuitry, connected to the threads of light sources 150A-150C and the pressure sensor. The pressure sensor can provide, to the controller, an indication of the amount of pressure being applied to the seat portion, e.g., in the form of a change in current or voltage. Based on this indication, the controller can determine when a person is sitting in the self-cleaning seat 101 or when a person has left the self-cleaning seat 101. The controller can be configured to initiate a cleaning cycle when a person gets out of the self-cleaning seat 101, e.g., to clean the self-cleaning seat 101 between each occupancy of the self-cleaning seat 101.

In FIG. 1, the triggering mechanism 140 is shown as a flat sheet, e.g., that includes a pressure-sensitive sheet, that covers a central region of the seat portion 111. In other examples, a triggering mechanism 140 that is arranged in or below the fabric surface may cover a larger or smaller portion of the fabric surface.

The self-cleaning seat 101 can also include a mechanical triggering mechanism that initiates a cleaning cycle in response to the seat portion 111 of the self-cleaning seat 101 moving into the closed or up position when a person gets out of the self-cleaning seat 101. When seat portion 111 pivots about the rod 160, seat portion 111 can press or release an end stop limit switch, a potentiometer, an encoder, a Hall effect sensor, or a mechanical button or switch, triggering the cleaning cycle. Similar to the above-mentioned pressure sensor, a mechanical triggering mechanism can include a controller (e.g., a microcontroller), connected to the threads of light sources 150A-150C and the aforementioned component.

Other triggering mechanisms can also be used. For example, the threads of light sources 150A-150C can also include light sensors that are also connected to a controller. When light is detected by the light sensors, indicating that a person is not sitting in the self-cleaning seat 101, the controller can initiate the cleaning cycle. In another example, a controller (e.g., server) in the cloud can control the cleaning cycles of multiple self-cleaning seats (e.g., based on a timer).

In another example, a motion or occupancy sensor can be used to initiate the cleaning cycles of self-cleaning seats 101. For example, when a theater room transitions from an occupied state to a non-occupied state, the cleaning cycle for each self-cleaning seat 101 in the room can be initiated.

In another example, the triggering mechanism 140 can include a moisture sensor. In this example, the triggering mechanism can initiate a cleaning cycle in response to detecting moisture on a surface (e.g., on a seat) as this can be indicative of a spilled liquid. Prior to initiating the cleaning cycle, the triggering mechanism can detect whether a person is sitting in the seat (e.g., using the pressure sensor or occupancy sensor described above). If a person is not detected, the triggering mechanism can initiate the cleaning cycle. In another example, a pH sensor can be used to check the pH of any detected moisture. If a liquid that contacts the surface has a pH within a particular range, the triggering mechanism can initiate a cleaning cycle.

In another example, the cleaning cycle can be initiated automatically or manually after an event. A controller can use ticket purchasing information to determine which seats were occupied and initiate cleaning cycles for the seats that were occupied, while not initiating cleaning cycles for unoccupied seats. This can be used in combination with mechanical triggering mechanisms and/or occupancy sensors to determine whether non-purchased seats were nonetheless occupied at some point during the event.

Referring again to FIGS. 1 and 2, a cleaning cycle for the self-cleaning seat 101 can include activating (e.g., turning on the threads of) light sources 150A-150C. When the light sources are on, the light emitted by the light sources activates the photocatalyst, causing a reaction that creates reactive substances that decompose organic compounds on the fabric surfaces of the back portion 110, the seat portion 111, and the arm rests 112. The threads of light sources 150A-150C can be controlled independently in some cases. For example, the light sources 150A can be activated while the light sources 150B and 150C are not activated.

A self-cleaning device can have multiple regions that are cleaned differently and/or separately. For example, some regions may be more prone to stains or contaminants than other regions. In this example, the regions that are more prone to stains or contaminants can be cleaned for longer periods of time and/or with higher intensity light. Each region can have separate light sources that are activated for a cleaning cycle for the region.

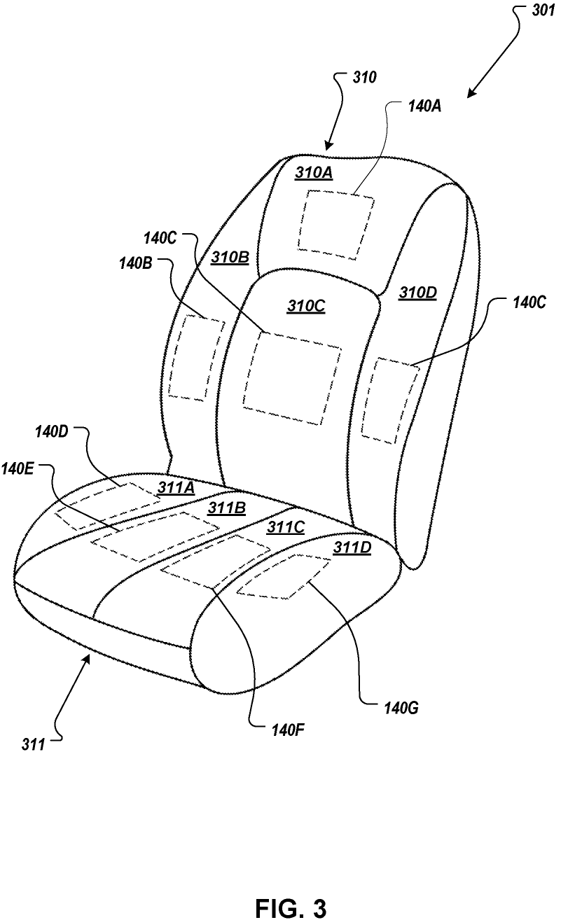

For instance, FIG. 3 depicts an example of a further self-cleaning seat 301. The self-cleaning seat 301 includes a back portion 310 and a seat portion 311 that each include an outer surface made of fabric. The back portion 310 includes multiple back regions 310A-310D that are separated (e.g., by seams). Similarly, the seat portion 311 includes multiple seat regions 311A-311D that are separated by seams. In some implementations, wires may be routed (e.g., between a controller or triggering mechanism 140 and a light source) via the seams. For example, by dividing the self-cleaning seat 301 into multiple portions wires can be routed via seems rather than across hinges of the self-cleaning seat 301. In this way, by avoiding routing wires across hinges, the self-cleaning seat 301 reduces a possibility of damage to the wires. In some implementations, each portion 310 and 311 may have a structure such that each portion 310 and 311 is stabilized within the self-cleaning seat 301 (e.g., without sewing to create pockets into which components of each portion 310 and 311 are disposed). In other words, each portion 310 may have an internal structure and an opening that can be used to insert and/or adjust components of the self-cleaning seat 301, such as light sources, electronics, or wires thereof. As illustrated, each portion 310A-310D and 311A-311D can include a triggering mechanism 140A-140G that is specific to that region. The triggering mechanisms 140A-140G can be configured to selectively activate the light source(s) for particular regions. Selectively activating can mean that the light source(s) for some regions 310A-310D are activated and not for other regions 310A-310D. Selectively activating can also mean that the light source(s) are activated for different durations and/or that light intensity differs across regions. Although not shown in FIG. 3, each portion 310A-310D and 311A-311D can include one or more light sources embedded in the fabric.

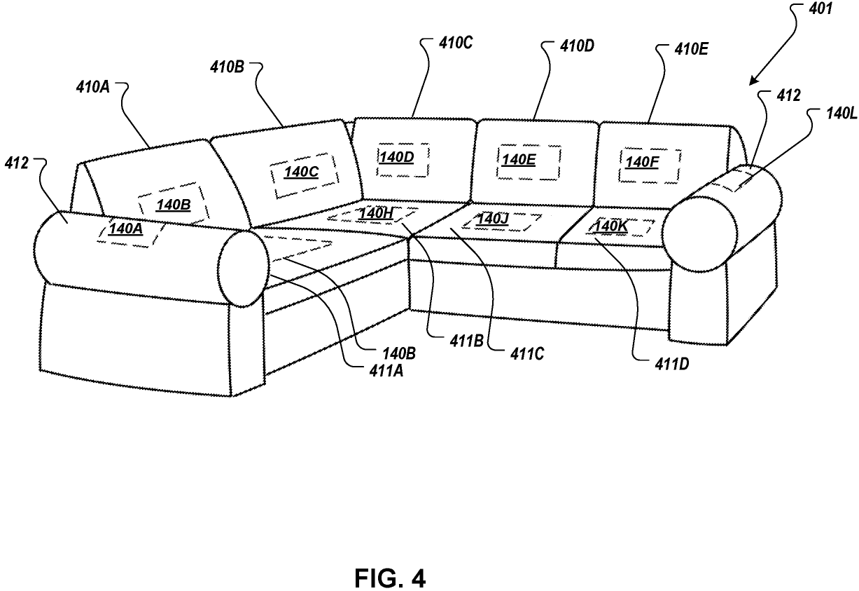

FIG. 4 depicts a further example of a self-cleaning seat 401. In FIG. 4, the self-cleaning seat 401 is a large sectional sofa that may seat multiple people at once. The seat 401 includes multiple back portions 410A-410E, a plurality of seat portions 411A-411D, and a pair of arm rests 412. The back portions 410A-410E, the seat portions 411A-411D, and arm rests 412 each may include an outer surface made of fabric. Similarly to FIG. 3, the seat 401 includes multiple triggering mechanisms 140A-140K that allow selective activation of the cleaning cycles. Although not shown in FIG. 4, each portion 410A-410E and 411A-411D includes one or more light sources embedded in the fabric.

Referring again to FIG. 2, the example cleaning cycle 200 includes terminating 206 the cleaning cycle 200 by deactivating (e.g., turning off) the one or more light sources. In some instances, the light sources are deactivated in response to a timer for the cleaning cycle expiring. In instances in which the cleaning cycle 200 is initiated manually, the cleaning cycle 200 can also be terminated manually.

FIG. 5 is a schematic overview of a method 500 of manufacturing a self-cleaning device. For example, the method 500 can be used to manufacture the fabric outer surface of any of the self-cleaning seats 101, 301, 401 described above. The method 500 includes obtaining 502 a fabric that will be disposed on the surface of the device, coating 504 the outer surface of the fabric with a photocatalyst, and embedding 506 one or more light sources in the fabric.

In some instances, coating 504 the outer surface of the fabric with a photocatalyst can include pre-treating the fabric. Pre-treating the fabric can include the use of plasma treatment, corona treatment, or flame treatment to name a few examples. Pre-treating the fabric can also include washing the fabric before the plasma treatment, corona treatment, or flame treatment. The fabric can be washed in a sonicated bath using non-ionic detergent, for example. Optionally, a primer may be applied after the plasma treatment, corona treatment, or flame treatment.

Plasma treatment exposes the fabric surface to plasma gas. The plasma gas particles can modify the properties of the fabric fibers by depositing chemical materials (referred to as “plasma polymerization”) or by removing material (referred to as “plasma etching”). The plasma gas is an ionized gas with equal density of positive and negative charges that exist across a wide temperature and pressure range. Depending on the specific gas, plasma gas can include free electrons, ions, or free radicals, for example. Unlike submersion-based pre-treatment processes, the plasma gas particles modify the surface structure of the fibers that allow coating to adhere to the fibers without modifying the fibers’ internal structure.

Corona treatment exposes the fabric surface to high-frequency corona discharge (electrically ionized air) that increases the functional groups on the fabric surface that allow the photocatalytic coating to adhere to the fabric. Specifically, corona treatment increases the surface tension of the fabric fibers. Specifically, corona discharge breaks oxygen molecules at the atomic level. The resulting atoms bond with molecule ends of the fabric fibers, resulting in a chemically active surface that is receptive to adhesives, inks, and coatings.

Flame treatment exposes the fabric surface to ionized hydrocarbon gas. Flame treatment can create oxidized species on the fiber surface, as well as form hydroxyl, carboxyl and carbonyl functionalities. In some instances, flame treatment can achieve high surface energy levels (dyne levels) at high production speeds.

In addition to or separately from a pre-treatment process, coating 504 the outer surface of the fabric with a photocatalyst can utilize spraying, painting, direct coating or floating knife coating, direct roll coating, or padding techniques to name a few examples. In instances in which a pre-treatment process has been performed, the coating may be applied as soon as possible after the pre-treatment process.

Direct coating or knife coating applies a viscous photocatalyst to the fabric while the fabric is placed under tension and run below a knife blade. The distance between the fabric surface and the knife blade can be adjusted to adjust the thickness of the coating. The angle between then fabric surface and the knife blade can also be adjusted to modify coverage of the coating on the fabric. Direct coating may be suited for filament yarns.

Direct roll coating uses a roller suspended in a liquid photocatalyst solution to roll the solution across the fabric surface. Excess solution may be scraped from the roller using a blade arranged adjacent to the roller.

Padding can include submerging the fabric in a liquid photocatalyst solution and using rollers to remove the excess solution.

In the present examples, coating 504 the outer surface of the fabric with a photocatalyst can further include drying, and optionally curing, the coated fabric.

In some instances, the method 500 further includes coating the fabric with a hydrophobic coating before or after the fabric has been coated with the photocatalyst.

Referring in addition to FIGS. 6A to 6H, examples of self-cleaning devices 600 that can be obtained using, for example, the method 500 are explained. The self-cleaning devices 600 can be incorporated, for example, into the self-cleaning seats 101, 301, or 401 in FIGS. 1, 3, or 4, respectively, among other examples.

As described, the method 500 includes obtaining 502 a fabric 612, as shown in FIGS. 6A to 6H. In some instances, the fabric 612 is a material made of natural or synthetic fibers (e.g., by weaving or knitting the fibers). As shown in FIGS. 6G and 6H, the fabric 612 may be a fiber optic fabric that includes ultra-thin optical fibers such as the threads 626 woven or stitched into a synthetic fabric 612.

The method 500 further includes coating 504 the outer surface of the fabric 612 with a photocatalyst using any of the techniques described above, for example. Thus, the self-cleaning devices 600 each include a photocatalytic coating 610 arranged on top of the fabric. Although FIGS. 6A to 6H schematically depict the photocatalytic coating 610 as a distinct layer arranged above the fabric 612, the photocatalytic coating may penetrate into the fabric 612 and coat the individual fabric fibers.

In some cases, the method 500 further includes coating the photocatalytic coating 610 with a hydrophobic coating 608 (FIG. 6E). The hydrophobic coating 608 or super-hydrophobic coating may be configured to repel water or other liquids. For example, if a liquid is spilled onto the self-cleaning device 600, the hydrophobic coating 608 may cause the liquid to form beads that roll off the surface of the device 600. Any residual contaminants that penetrate the fabric 612 may be neutralized using the process described in reference to FIG. 2.

Although FIG. 6E depicts the optional hydrophobic coating 608 above the photocatalytic coating 610, the hydrophobic coating 608 may be arranged below the fabric 612 in some implementations. For example, if a liquid is spilled onto the self-cleaning device 600, the photocatalytic coating 610 and the fabric 612 may absorb the spill. The hydrophobic coating 608 may prevent seepage and penetration of the spilled liquid into the other elements of the device 600 (e.g., the light-diffusing fabric 614 or the light source(s) 618). Meanwhile, the fabric 612 may be cleaned using the process described in reference to FIG. 2.

The method 500 further includes embedding 506 one or more light sources 618 in the fabric. For example, one or more threads 626 of fibers having LEDs embedded therein can be interwoven or intertwined into the fabric (e.g., as shown in FIGS. 6G and 6H). In other examples, one or more light sources 618 can be disposed behind or under the fabric 612. Thus, in the present disclosure, the expression “embedded” is not limited to embodiments in which the light source is interwoven or intertwined with the fibers of fabric 612.

In some instances, the one or more light sources 618 can include LEDs. The LEDs can be visible light LEDs that emit visible light, ultraviolet (UV) lights that emit UV light, depending on the photocatalyst material. The light sources 618 can include LED strands, LED fibers, fiber optics, or electroluminescent wires. The light sources 618 can include individual LEDs that are attached to an underside of the fabric 612. The light sources 618 can also include printed LEDs. The number of light sources 618 may vary. For example, as shown in FIG. 6F, a single large light source 618 may be arranged to illuminate the fabric 612. Such a light source may emit fluorescent or incandescent light.

The light sources 618 can be arranged in a pattern such that the light sources emit light that diffuses and hits every part of the coated surface. As shown in FIGS. 6A, 6B, 6E, and 6F, the one or more light sources 618 can be arranged facing the fabric 612. In other examples, the one or more light sources 618 can be arranged facing away from the fabric 612, as shown in FIGS. 6C and 6D. As shown in FIGS. 6G and 6H, a light source may not have a specific directionality towards or away from the fabric 612. Independently of the direction in which the one or more light sources 618 are facing, the method 500 may further include arranging a reflective (or refractive) layer 616 below the one or more light sources 618 (e.g., on the side of the light source(s) 618 opposite from the fabric 612). For example, the reflective layer 616 may include a flexible film that includes biaxially-oriented polyethylene terephthalate (boPET).

As shown in FIGS. 6A, 6B, 6C, and 6E, the method 500 can further include arranging a light-diffusing fabric 614 between the fabric 612 and the one or more light sources 618. The light-diffusing fabric 614 spreads the light emitted by one or more discrete light sources 618 evenly across the coated fabric 612. For example, the light-diffusing fabric 614 may be a white, translucent fabric made of polyester. Some examples may not include a light-diffusing fabric 614. For example, the light source 618 may include a light-diffusing panel or a diffused LED backlight with built-in diffusion capabilities. In some instances, the light source may include a diffusing element, such as the reflective layer 616 (e.g., as shown in FIG. 6D) or a cone 619 (e.g., as shown in FIG. 6F) that focuses the light from the light source 618 across the fabric 612. In other examples, the light sources are distributed throughout the fabric 612 (e.g., in the threads 626, as shown in FIGS. 6G and 6H).

The method 500 can further include providing a backing 620 to support the self-cleaning device 600. In some instances, the backing 620 can be integral to the one or more light sources 618 (e.g., part of an LED light panel). The backing 620 may also be a thin substrate that results in a self-cleaning device 600 with a low height profile that can be mounted on the surface of an existing object (e.g., as a fabric cover). Referring again to FIGS. 1, 3, and 4, the backing 620 of FIGS. 6A to 6H may also schematically represent a larger structure (e.g., the portions of a back portion 110, 310, 410 or seat portion 111, 311, 411 apart from the outer fabric surface). Such a design may enable the integration of a smaller number of larger light sources, as shown in FIG. 6F.

The method 500 can further include connecting the one or more light sources to a controller, as described above, and optionally to a triggering mechanism, such as triggering mechanism 140. Depending on the specific design, the triggering mechanism 140 may be arranged above the backing 620 shown in FIGS. 6A-6H. In some instances, the backing 620 may be thin and flexible enough so that the entire self-cleaning device 600, as shown, can be arranged on top of a suitable triggering mechanism 140.

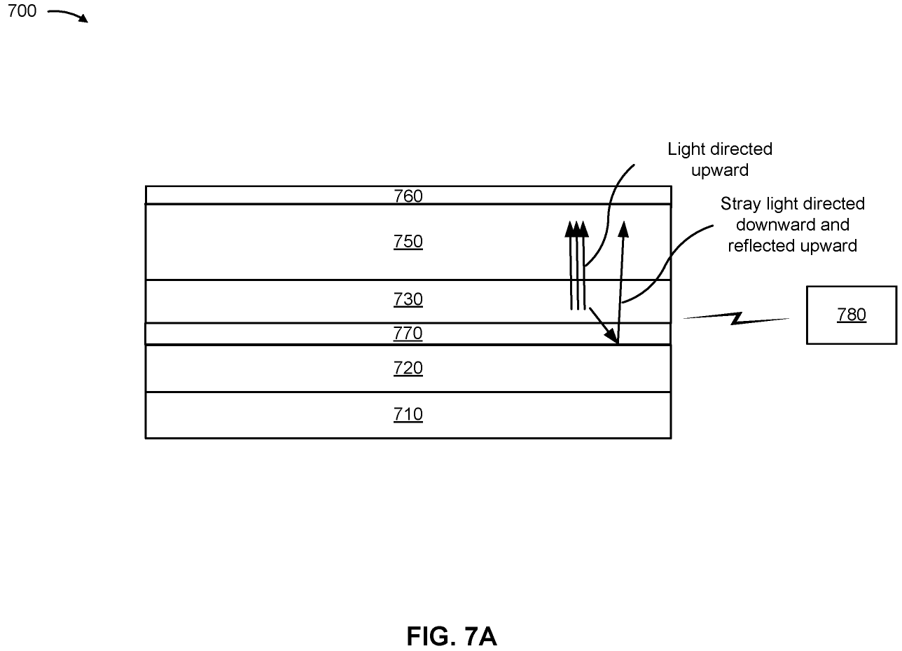

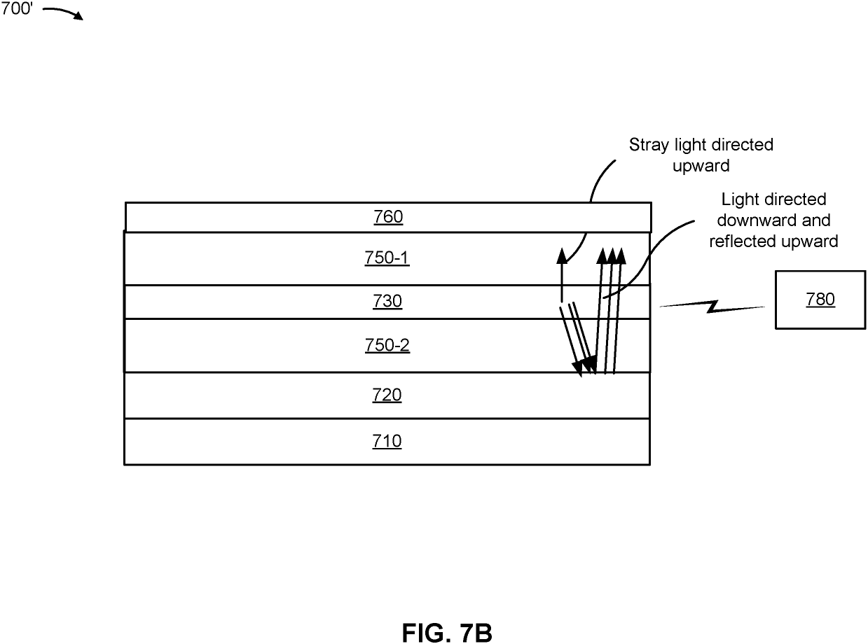

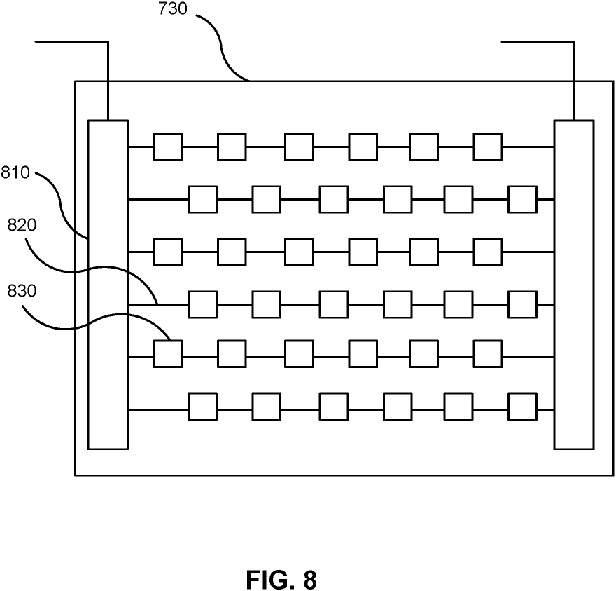

FIGS. 7A-7B and FIG. 8 are diagrams of example self-cleaning seats 700/700'. The self-cleaning seats 700/700' may correspond to one or more of the self-cleaning devices or the self-cleaning seats described above and/or may perform one or more of the processes described above.

As shown in FIGS. 7A-7B, self-cleaning seats 700/700' include a backing layer 710, a reflective layer 720, a light-emitting fiber layer 730, a light-diffusing spacer 750, and a cover layer 760. As shown in FIG. 7A, self-cleaning seat 700 may include a lamination layer 770 (e.g., a heat lamination layer that may bind light-emitting fiber layer 730 to reflective layer 720). As shown in FIG. 7B, rather than a single light-diffusing spacer 750, self-cleaning seat 700' may include a first light-diffusing spacer 750-1 and a second light-diffusing spacer 750-2. In some implementations, self-cleaning seats 700/700' may include or be in communication with a controller 780, which may correspond to one or more controllers described above.

The backing layer 710 may be a material that provides a non-slip functionality. For example, the backing layer 710 may include a silicone rubber material that, when disposed on another surface (e.g., a car seat) prevents the backing layer 710 and the self-cleaning seat 700 from slipping on the other surface. Additionally, or alternatively, the backing layer 710 may include a silicone rubber material that prevents another layer of the self-cleaning seat 700 (e.g., the reflective layer 720, which may be disposed on top of the backing layer 710) from slipping on the backing layer 710. In other words, the backing layer 710 may have silicone rubberized elements on both sides (e.g., a top surface and/or a bottom surface) of the backing layer 710. As described below, although spatially relative terms, such as “top” and “bottom” are used, it is contemplated that a self-cleaning device may be disposed in any orientation, resulting in components being in different spatial orientations.

In some implementations, the backing layer 710 may include a discrete set of silicone rubber elements. For example, the backing layer 710 may include a textile material that is impregnated or covered with silicone rubber beading (e.g., on a bottom side and/or a top side of the textile material). In this case, the silicone rubber beading is disposed to prevent slipping. Further, the backing layer 710 may provide structural support for the self-cleaning seat 700 and/or protection for other components disposed within the self-cleaning seat 700. In this way, the backing layer 710 improves user experience with the self-cleaning seat 700 by improving comfort (e.g., as a result of reduced slippage of the self-cleaning seat 700 and/or layers thereof) and durability (e.g., as a result of protecting components disposed within the self-cleaning seat 700 from damage).

The reflective layer 720 may be a reflective material disposed on the backing layer 710 to provide a reflective functionality. For example, as shown in FIG. 7A, despite a light source of the light-emitting fiber layer 730 being oriented to emit light upward toward the cover layer 760, some of the light (e.g., stray light) may be directed downward toward reflective layer 720. In this case, the reflective layer 720 reflects the stray light back upward toward the cover layer 760, thereby reducing a total amount of power used by the light source to achieve a desired amount of light incident on the cover layer 760. Additionally, light from the light source achieves greater diffusion over greater path lengths. Accordingly, reflecting some light off reflective layer 720 achieves a greater amount of light diffusion at the cover layer 760 than is achieved by directing all light toward the cover layer 760 directly.

In some implementations, as shown in FIG. 7B, the light source of the light-emitting fiber layer 730 may be configured to emit light downward toward reflective layer 720. In this case, by directing a greater proportion of light toward reflective layer 720 for reflection (e.g., relative to the self-cleaning seat 700 where light is generally directed upward), the self-cleaning seat 700' achieves even greater light diffusion by increasing a path length for a greater proportion of emitted light. In other words, the self-cleaning seat 700' achieves a greater light path length between light-emitting fiber layer 730 and cover layer 760 (via reflection off reflective layer 720) than self-cleaning seat 700 achieves directly between light-emitting fiber layer 730 and cover layer 760. This may enable self-cleaning seat 700' to achieve a desired level of dispersion or diffusion with a less thick light-diffusing spacer 750 (or spacers 750-1 and 750-2), thereby enabling manufacture of lower profile self-cleaning devices or self-cleaning seats. In some implementations, the reflective layer 720 is a reflective material that is manufactured to provide additional diffusion of light reflecting off reflective layer 720. In other words, rather than being a non-diffusive retro-reflector, the reflective layer 720 may have a diffusive material surface to achieve increased light diffusion when the light is reflected.

In some implementations, the reflective layer 720 may include a vinyl reflective material forming a reflective surface of the reflective layer 720. For example, the reflective layer 720 may include a flexible vinyl layer material with a silver or chrome-finished surface. In this case, by using a flexible vinyl layer material, the reflective layer 720 enables conformance to different shaped surfaces (e.g., seats). Moreover, the reflective layer 720 avoids poor user experience, which can occur from a material that generates noise when flexed or has a crinkly (e.g., rigid or non-conformable) feel when sat upon. In some implementations, the reflective layer 720 may have a non-woven silk backing with flexural rigidity to allow lamination (using lamination layer 770) of the light-emitting fiber layer 730, and light sources thereof, on top of the reflective layer 720. In this case, by providing flexural rigidity, the reflective layer 720 provides structure for the light-emitting fiber layer 730.

The light-emitting fiber layer 730 may be a reflective diode system. For example, the light-emitting fiber layer 730 may be a light-fiber layer or an LED-fiber layer. As shown in FIG. 8, the light-emitting fiber layer, in some implementations, includes a set of flexible printed circuit boards (PCBs) 810, a set of fibers 820, and a set of emitters 830 (e.g., a set of LEDs or diodes). In this case, the set of fibers 820 may include a grid of LED fibers or flex-strips that connect the set of emitters 830 to the set of PCBs 810. The set of emitters 830 are configured to emit light in a configured direction (e.g., upward toward the cover layer 760 in self-cleaning seat 700 or downward toward reflective layer 720 in self-cleaning seat 700'). Although light emitted from the light-emitting fiber layer 730 is described with a directionality, it is contemplated that some light will be emitted in other directions, as described above. In some implementations, another type of light emitting layer or set of components other than light-emitting fibers may be possible.

In some implementations, the light-emitting fiber layer 730 may include LEDs connected in parallel and/or in series. For example, the light-emitting fiber layer 730 may have a set of electrical traces to connect a first pair of LEDs or pair of groups of LEDs in series and a second pair of LEDs or pair of groups of LEDs in parallel. By having some LEDs or groups of LEDs connected in series and other LEDs or groups of LEDs connected in parallel (it is contemplated that the pairs or pairs of groups may share some LEDs), the light-emitting fiber layer 730 may achieve greater uniformity of emission relative to other layouts, which may ensure greater uniformity of cleaning of the cover layer 760.

Returning to FIGS. 7A and 7B, and as described above, different LEDs or groups thereof may be independently controllable by the controller 780. For example, LEDs of the light-emitting fiber layer 730 may be divided into 2, 3, 4, 5, or more sections that are independently controllable. In some implementations, the controller 780 may control the different sections based on an input factor (e.g., whether a person is detected as having touched a particular section). Additionally, or alternatively, the controller 780 may control the different sections according to a sequence. For example, the controller 780 may activate and deactivate each section in sequence to avoid a peak power draw of the light-emitting fiber layer 730 exceeding a threshold. In other words, by activating a single section at a time, rather than the whole light-emitting fiber layer 730 at once, the controller 780 may reduce peak power draw by the light-emitting fiber layer 730, which enables usage of a self-cleaning seat 700 in a power-limited deployment scenario and/or which ensures that heating of the self-cleaning seat 700 by the LEDs does not exceed a threshold temperature.

In some implementations, the light-emitting fiber layer 730 is configured with a maximum power output. For example, the light-emitting fiber layer 730 (e.g., the controller 780 driving the light-emitting fiber layer 730) may have a maximum power output threshold to avoid heating by the LEDs thereof exceeding a threshold temperature at the cover layer 760. In some implementations, one or more other layers (e.g., the above-mentioned layers or a dedicated layer) of the self-cleaning seat 700 may be configured for heat dispersal. For example, the self-cleaning seat 700 may include a heat sink layer to avoid excess heating of the cover layer 760. Additionally, or alternatively, the controller 780 may include or connect to a temperature sensor and may control an amount of power at the light-emitting fiber layer 730 to avoid excess temperature at the cover layer 760 based on a measurement performed by the temperature sensor. In some implementations, the controller 780 may have a heat control input. For example, the controller 780 may receive a control signal that a particular level of heat is to be provided at the cover layer 760 (e.g., to achieve a heated seating functionality), and may control the LEDs of the light-emitting fiber layer 730 to self-clean the self-cleaning seat 700 and to provide the particular level of heat. In some implementations, a quantity or density of LEDs per unit area of the light-emitting fiber layer 730 may be configured based on the maximum temperature, an amount of light that is to be incident on the cover layer 760 to achieve self-cleaning, or another factor.

The light-diffusing spacer 750 may include one or more layers of material to diffuse light from the light-emitting fiber layer 730. For example, the light-diffusing spacer 750 may include a transparent or white colored material that disperses or diffuses light from the light-emitting fiber layer 730 with less than a threshold absorption of light by the light-diffusing spacer 750. In this case, the light-diffusing spacer 750 may have a transmissivity of greater than 50%, greater than 75%, greater than 90%, or greater than 95%, among other examples while dispersing or diffusing the light as the light passes through the light-diffusing spacer 750. In this way, the light-diffusing spacer 750 ensures a relatively uniform level of light is incident on each area of the cover layer 760 to achieve a relatively uniform level of self-cleaning.

In some implementations, the light-diffusing spacer 750 may include a flexible material that provides a soft seating surface for a person sitting on the self-cleaning seat 700 and/or a seat into which the self-cleaning seat 700 is incorporated. For example, the light-diffusing spacer 750 may include a vertically-oriented flexible monofilament polyester material (e.g., filaments are oriented linearly in a direction from the light-emitting fiber layer 730 to the cover layer 760). The light-diffusing spacer 750 may optically disperse light, provide cushioning, and/or provide sound dampening.

In some implementations, light-diffusing spacer 750 may be a multi-layer spacer. For example, multiple, discrete layers of polyester fibers may be stacked to form a light-diffusing spacer 750. Additionally, or alternatively, multiple, discrete light-diffusing spacers 750 may be provided, as shown in FIG. 7B. In this case, light-emitting fiber layer 730 may be disposed between light-diffusing spacers 750 (e.g., between light-diffusing spacer 750-1 and light-diffusing spacer 750-2) to increase a path length of light emitted by light sources of light-emitting fiber layer 730.

In some implementations, light-diffusing spacer 750 may have an exterior material (e.g., in which the vertically-oriented monofilament material is disposed). For example, a matrix of monofilament materials, forming an interior of light-diffusing spacer 750, may be disposed between textile or other material outer layers. In some implementations, light-diffusing spacer 750 may have a non-slip rubber transparent layer as an exterior of light-diffusing spacer 750. For example, the light-diffusing spacer 750 may have a transparent or translucent silicone rubber layer as an exterior to prevent slippage of the light-diffusing spacer 750 without absorbing light passing through the light-diffusing spacer 750 toward the cover layer 760. Additionally, or alternatively, a discrete non-slip rubber transparent layer may be disposed between the light-diffusing spacer 750 and the cover layer 760 as an additional non-slip layer (not shown). By adding the non-slip rubber transparent layer (e.g., as an exterior of light-diffusing spacer 750 or as an independent layer), the self-cleaning seat 700 reduces slippage between the light-diffusing spacer 750 and the cover layer 760, thereby improving seat feel and aesthetic appearance of a seat relative to a cover layer 760 that can bunch up against the light-diffusing spacer 750 (e.g., slip against the light-diffusing spacer 750).

The cover layer 760 may be a ripstop nylon material cover applied on top of the light-diffusing spacer 750 (and/or a non-slip, transparent silicone rubber layer, as described above). For example, the cover layer 760 may be a textile material configured to allow light to pass through to the surface of the fabric. It is contemplated that other materials may be possible, such as a natural material or a synthetic material. In some implementations, a structure of the cover layer 760 may provide additional diffusion of light emitted from the light-emitting fiber layer 730 toward the cover layer 760, thereby enabling a further reduction in thickness of the self-cleaning seat 700, as described above.

In some implementations, the cover layer 760 may have a relatively fine warp and a relatively fine denier to achieve the above-mentioned diffusive effect. In some implementations, a coating may be applied to the cover layer 760, as described above. For example, the cover layer 760 may have a photocatalyst coating or covering. In some implementations, the cover layer 760 may have a treatment applied to improve adherence of a photocatalyst (e.g., as a precoating treatment, a photocatalyst coating treatment, or a post-coating treatment), such as a Corona treatment, a brushing treatment, a washing treatment (e.g., with non-ionic detergent), a priming treatment, a sonication treatment, a drying treatment, or a curing treatment (e.g., a heat curing or a room temperature curing after applying the photocatalyst), among other examples. Additionally, or alternatively, the cover layer 760 may have a treatment applied to improve performance of the photocatalyst, such as a nitrogen doping treatment (e.g., to improve low-light sensitivity of the photocatalyst).

As indicated above, FIGS. 7A-7B and FIG. 8 are provided as examples. Other examples may differ from what is described with regard to FIGS. 7A-7B and FIG. 8. The number and arrangement of devices shown in FIGS. 7A-7B and FIG. 8 are provided as examples. In practice, there may be additional devices, fewer devices, different devices, or differently arranged devices than those shown in FIGS. 7A-7B and FIG. 8. Furthermore, two or more devices shown in FIGS. 7A-7B and FIG. 8 may be implemented within a single device, or a single device shown in FIGS. 7A-7B and FIG. 8 may be implemented as multiple, distributed devices. Additionally, or alternatively, a set of devices (e.g., one or more devices) shown in FIGS. 7A-7B and FIG. 8 may perform one or more functions described as being performed by another set of devices shown in FIGS. 7A-7B and FIG. 8.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs (one or more modules of computer program instructions encoded on a tangible non transitory program carrier for execution by, or to control the operation of, data processing apparatus). Alternatively or in addition, the program instructions can be encoded on an artificially generated propagated signal (e.g., a machine generated electrical, optical, or electromagnetic signal) that is generated to encode information for transmission to suitable receiver apparatus for execution by a data processing apparatus. The computer storage medium can be a machine readable storage device, a machine readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry (e.g., an FPGA (field programmable gate array) or an ASIC (application specific integrated circuit)). The apparatus can also include, in addition to hardware, code that creates an execution environment for the computer program in question (e.g., code that constitutes processor firmware, a protocol stack, a database management system, an operating system, or a combination of one or more of them).

A computer program (which may also be referred to or described as a “program,” “software,” a “software application,” a “module,” a “software module,” a “script,” or “code”) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry (e.g., an field programmable gate array (FPGA) or an application specific integrated circuit (ASIC)).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device (e.g., a mobile telephone, a personal digital assistant (PDA)), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks; magneto optical disks); and CD read-only memory (ROM) and DVD ROM disks. The processor and the memory can be supplemented by, or incorporated in, special purpose logic circuitry.

To provide for interaction with a user, embodiments of the subject matter described in this specification can be implemented on a computer having a display device (e.g., a cathode ray tube (CRT) monitor, a liquid crystal display (LCD) monitor, or an organic LED (OLED) display), for displaying information to the user, as well as input devices for providing input to the computer (e.g., a keyboard, a mouse, or a presence sensitive display or other surface). Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. In addition, a computer can interact with a user by sending resources to and receiving resources from a device that is used by the user; for example, by sending web pages to a web browser on a user’s client device in response to requests received from the web browser.

Embodiments of the subject matter described in this specification can be implemented in a computing system that includes a back end component (e.g., as a data server) or that includes a middleware component (e.g., an application server) or that includes a front end component (e.g., a client computer having a graphical user interface or a Web browser through which a user can interact with an implementation of the subject matter described in this specification) or any combination of one or more such back end, middleware, or front end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature’s relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A self-cleaning seat, comprising:
a cover layer with a photocatalyst;
a light-emitting fiber layer including one or more light sources;
a light-diffusing spacer configured to diffuse light emitted from the light-emitting fiber layer and disposed between the cover layer and the light-emitting fiber layer; and
a triggering mechanism that activates a cleaning cycle by activating the one or more light sources.

2. The self-cleaning seat of claim 1, further comprising:
a backing layer, wherein the light-emitting fiber layer is disposed between the backing layer and the light-diffusing spacer.

3. The self-cleaning seat of claim 2, wherein the backing layer includes a silicone rubber layer.

4. The self-cleaning seat of claim 2, wherein the backing layer includes a set of rubberized elements on both sides of the backing layer.

5. The self-cleaning seat of claim 1, further comprising:
a reflective layer, wherein the light-emitting fiber layer is disposed between the reflective layer and the light-diffusing spacer, and wherein the reflective layer is configured to direct at least a portion of light emitted from the one or more light sources toward the cover layer.

6. The self-cleaning seat of claim 5, wherein the one or more light sources of the light-emitting fiber layer are oriented toward the light-diffusing spacer and away from the reflective layer.

7. The self-cleaning seat of claim 5, wherein the one or more light sources of the light-emitting fiber layer are oriented away from the light-diffusing spacer and toward the reflective layer.

8. The self-cleaning seat of claim 5, wherein the light-diffusing spacer is a first light-diffusing spacer, and
further comprising:
a second light-diffusing spacer, wherein the light-emitting fiber layer is disposed between the second light-diffusing spacer and the first light-diffusing spacer,
wherein the one or more light sources are oriented toward the second light-diffusing spacer and the reflective layer and are oriented away from the first light-diffusing spacer.

9. The self-cleaning seat of claim 1, further comprising:
a heat lamination layer configured to attach the light-emitting fiber layer to at least one other layer.

10. The self-cleaning seat of claim 1, wherein the light-emitting fiber layer includes a set of electrical traces to connect the one or more light sources to the triggering mechanism,
the one or more light sources including at least a first pair of light sources that are connected in series by a first one or more electrical traces, of the set of electrical traces, and a second pair of light sources that are connected in parallel by a second one or more electrical traces of the set of electrical traces.

11. The self-cleaning seat of claim 1, wherein the light-diffusing spacer includes a vertically-oriented, monofilament polyester, diffusive material.

12. A method for manufacturing a self-cleaning seat comprising:
obtaining a cover layer and a light-emitting fiber layer, the light-emitting fiber layer including a plurality of light sources;
disposing a light-diffusing spacer between the cover layer and the light-emitting fiber layer;
coating the cover layer with a photocatalyst;
disposing a heat lamination layer, such that the light-emitting fiber layer is between the heat lamination layer and the light-diffusing spacer;
disposing a reflective layer, such that the heat lamination layer is between the reflective layer and the light-emitting fiber layer, the heat lamination layer binding the light-emitting fiber layer to the reflective layer; and
disposing a backing layer, such that the reflective layer is between the backing layer and the light-emitting fiber layer.

13. The method of claim 12, further comprising:
disposing a non-slip layer between the light-diffusing spacer and the cover layer.

14. The method of claim 13, wherein the non-slip layer includes a transparent silicone rubber material.

15. The method of claim 12, wherein coating the cover layer with the photocatalyst comprises:
applying at least one pre-coating treatment, coating treatment, or post-coating treatment to the cover layer to enable the photocatalyst to adhere to the cover layer.

16. The method of claim 15, the at least one pre-coating treatment, coating treatment, or post-coating treatment includes at least one of:
a washing treatment,
a drying treatment,
a curing treatment,
a priming treatment,
a corona treatment, or
a sonication treatment.

17. A self-cleaning seat comprising:
a back portion that comprises at least one first self-cleaning device;
a seat portion that comprises at least one second self-cleaning device; and
a triggering mechanism,
wherein the at least one first self-cleaning device and the at least one second self-cleaning device each includes: a non-slip backing layer, a reflective layer disposed between the non-slip backing layer and a lamination layer, a spacer layer disposed between a cover layer and a light-emitting fiber layer including a plurality of light sources, wherein the light-emitting fiber layer is disposed between the spacer layer and the lamination layer, wherein a photocatalytic coating is disposed on the cover layer, and
wherein the triggering mechanism is configured to activate a cleaning cycle by activating the at least one first self-cleaning device and the at least one second self-cleaning device.

18. The self-cleaning seat of claim 17, wherein the triggering mechanism is configured to independently control each self-cleaning device of the at least one first self-cleaning device and of the at least one second self-cleaning device.

19. The self-cleaning seat of claim 17, wherein the cover layer is a ripstop nylon material.

20. The self-cleaning seat of claim 17, wherein one or more electrical traces connecting the triggering mechanism to the plurality of light sources are disposed in at least one seam of the self-cleaning seat.
